(19) United States
(12) Patent Application Publication
(10) Pub. No.: US 2014/0080102 A1
(43) Pub. Date: Mar. 20, 2014

(54) SYSTEM AND METHOD FOR A PERSONAL DIET MANAGEMENT

(71) Applicant: Srikanth Krishna, Bangalore (IN)

(72) Inventor: Srikanth Krishna, Bangalore (IN)

(21) Appl. No.: 14/116,760

(22) PCT Filed: May 11, 2012
(86) PCT No.: PCT/IN12/00346

§ 371 Date: Nov. 8, 2013

(30) Foreign Application Priority Data
May 11, 2011 (IN) 1660/CHE/2011

(51) Int. Cl. G09B 19/00

(52) U.S. Cl. CPC G09B 19/0092
USPC 434/127

(57) ABSTRACT

A system and method for enabling a personal diet management service is disclosed. The system enables users to communicate with the system and receive recommendations throughout the day. The system recommends recipes and restaurants serving the recipes based on a plurality of factors comprising of the calorie and nutrient intake of the person for each meal, identified deficiencies based on the recommended daily intake among others. The system also allows user to communicate with restaurants for reserving tables and specifying any further requests.

### PRIORITY DETAILS

The present application is a National Phase Application for PCT application No. PCT/1N2012/000346 filed on 11 May 2012, based on and claims priority from IN Applications bearing No. 1660/CHE/2011 Filed on 13 May 2011, the disclosure of which is hereby incorporated by reference herein

### TECHNICAL FIELD

The embodiments herein broadly relate to the field of computer assisted medical diagnostics and, more particularly, to diet management.

### BACKGROUND

Studies have shown that the weight of people all around the world is steadily increasing. The number of obese people is also on rise. This leads to many problems like heart disease, strokes, diabetes and so on. Few of the main reasons for weight gain are sedentary lifestyles, high stress, consumption of saturated fats and sugars and low fiber intake, leading to obesity. People are consuming more energy rich food than required by the body and right amount of vitamins and micro nutrients consumption through natural diet is very little practiced today on a day to day basis. This is forcing people who have more disposable income to consume vitamins and micro nutrient tablets which are available over the counter as a safety precaution. While people who do not have disposable income may just compromise their health with deficiency in certain vitamins and micro nutrients and hence vulnerable to certain diseases.

People are trying to combat weight gain through exercises, various different diet/nutrition programs, eating healthy food, dietary supplements and going to restaurants serving healthy food. Technology also provides a user with many tools, which can give user information on food intake, calories consumed, nutrition, exercises, health information, etc.

Web based applications have been suggested which allow a user to enter food consumed by them and see the calorie and nutrient breakdown. User can also specify their calorie requirement and applications can suggest food items the user should consume. There are many calorie calculators available too. There are many applications which suggest various diets to users based on the user entered general information like height, weight, and lifestyle and so on. Users need to share their general health status along with the food consumed by them on a regular basis. Many restaurants now provide the users with a detailed breakdown of calorie and nutrients in each one of their recipes.

Most of the available applications are rigid and not very proactive. The applications do not interact with user on a meal to meal basis and do not consider user preferences while suggesting food to be consumed. Most restaurants suggested to users by applications are based just on a location, time or cuisine specified by the user.

### SUMMARY

The present embodiment provides a real time system recommending recipes and restaurants to users through a web based or a mobile based application service, based on calculation of user's food intake for a day, users profile, total nutrient requirement for a day, location of the user and food preferences. The recommendations are sent to the user based on the time of the day, user preferences and nutrient requirements.

An embodiment of the present embodiment, discloses a system which can break down recipes into individual ingredients and calculate various essential nutrients present in a food item.

An embodiment of the present embodiment discloses a system which has large internet storage getting information from various sources like restaurant menus, recipes found in websites, ingredients knowledge base, social networking websites and many other sources.

An embodiment of the present allows users to enter and specify various parameters like food consumed by them, cuisine they would like to consume, time they would like eat, location they would prefer to dine and many others.

An embodiment of the present embodiment provides the user with an overall health analysis report on a monthly basis based on the food consumed and nutrient breakdown.

Further an embodiment of the present embodiment provides a method for restaurants to interact with users. The restaurants provide detailed menu information along with nutrient breakdown, current promotions, and timings to the system. The system can suggest recipes at a restaurant to users based on the user needs and enable further value added services like reservation and recommendations.

Further if a person is under medical condition(s) and certain food habits and contents are prescribed for a period of time, this application will help patients with right insights about recipe ingredients, calories, vitamins and micro nutrients and provide recommendation about meals that best fit the prescriptions

An embodiment of the present embodiment also helps users to rightly understand deficiency details about which vitamins or micro nutrients are consumed less compared to recommended dosage, on a daily basis (based on food consumption data entered by the user). This also helps further recommend any additional consumption of certain types of food to reduce the deficiency levels. This input can be used by the user to discuss with nutrition specialist or doctors, to understand if they need to take additional supplemental tablets for a certain specific vitamin or micro nutrient over a period of time.

Chef's special recipes which are unique can be published using this system or method, if restaurant(s) want to purchase these recipes this system will allow the purchase transaction and the restaurants that purchase these recipes can now start publishing this in their menu. Transaction fee can be charged by the person or organization using this system as a market place for selling and buying recipes.

These and other aspects of the embodiments herein will be better appreciated and understood when considered in conjunction with the following description and the accompanying drawings.

### BRIEF DESCRIPTION OF FIGURES

The embodiments herein will be better understood from the following detailed description with reference to the drawings, in which:

FIG. 1 is a block diagram illustrating a system used for providing personal diet management service;

FIG. 2 is block diagram showing the individual components of the decision engine 111 in FIG. 1.

FIG. 3A shows an example of information sent to a user device interface according to an embodiment of the present embodiment

FIG. 3B shows an example of information sent by a user from a user device interface

FIGS. 4a, 4b and 4c are flowcharts describing the process flow of the steps used by the system in determining the recommendations and nutritional calculation of current consumption.

FIGS. 5a and 5b are flowcharts describing how the decision engine 111 of FIG. 1 suggests recommendations to user and provides some value added services.

FIG. 6 is an exemplary application depicting creation of a personalized shopping list, according to embodiments as disclosed herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein. In the following description, for purposes of explanation, numerous specific details are set forth in order to provide a thorough understanding of the embodiment. It will be apparent, however, to one skilled in the art that the embodiment can be practiced without these specific details. In other instances, structures and devices are shown in block diagram form in order to avoid obscuring the embodiment.

Nutrients as referred to herein encompass all possible nutritional requirements of a human body, which include but are not limited to vitamins, carbohydrates, minerals, proteins, fats, micronutrients, calories which are available in public domain or any certified organization.

The nutritional needs of a user should be advised through a simple interactive system which suggests food items for each meal throughout the day, based on calorie and nutrient consumption on that day, general user consumption pattern and user preferences. Restaurants and recipes can also be suggested to a user based on the user's calories and nutritional requirements and user preferences.

If a person is already in a restaurant and trying to make a choice of what he or she should eat, this application can rank the choice that best fits him or her with a goal of fulfilling right amount of calories, vitamins and micro nutrients.

Chef's special recipes can be auctioned or sold to other restaurants for purchase, so they get the rights to publish purchased recipes in the restaurant's menu cards. Every time users look for recommendations of recipes, this solution will also check if restaurants are using any of the purchased Chef specials recipes of other restaurants and provide that information to users about when it was purchased and who is the original auctioneer or seller of this recipe. Using this system, market place for selling and buying special recipes can be formed with business interest wherein a transaction fee for selling and buying recipes can be charged by organization or person who is using this system for commercial purpose.

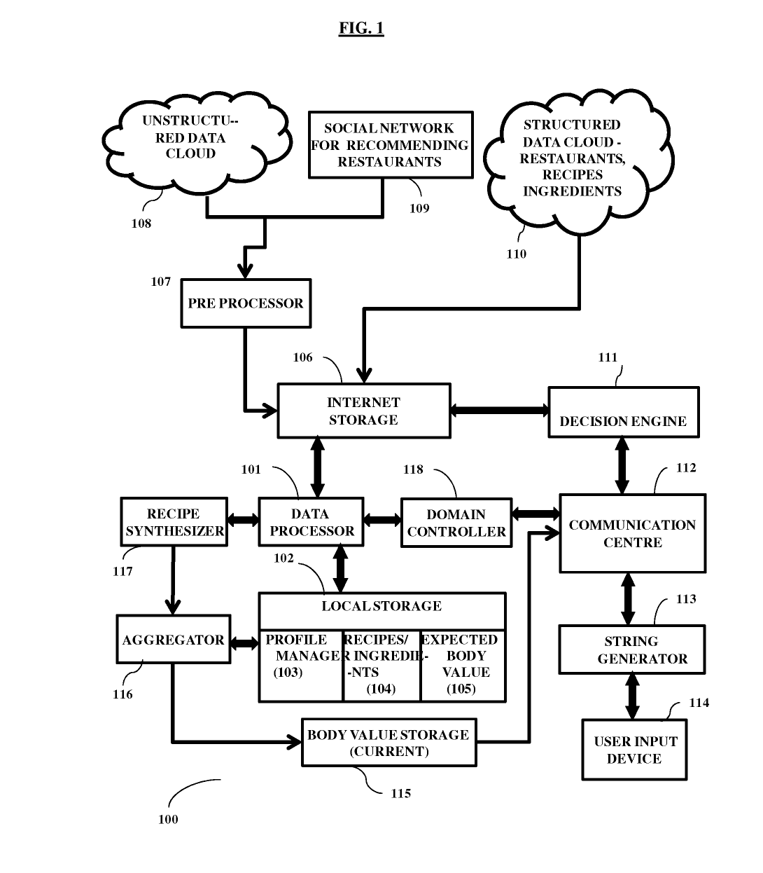

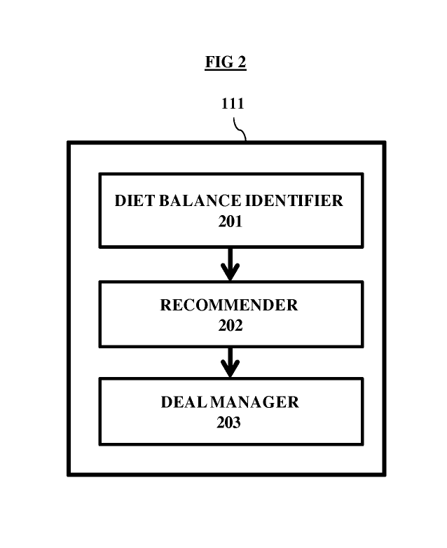

FIG. 1 is a block diagram illustrating a system 100 used for providing personal diet management service. Before starting the service, the system needs to build a knowledge base by collecting information from various data sources and stores them in an internet storage area 106. The internet storage area 106 acts like a server located in a data centre. Information is collected from both structured data clouds 110 and unstructured data clouds 109. Information is also collected from various social networking websites 108 which recommend restaurants. Information from the structured data clouds 110 includes information of recipes from various recipe websites, information of menu available in restaurants and information of ingredients used in food preparation from various knowledge bases. Each recipe can be prepared in different ways by using different ingredients or changing the process of cooking. All the different variations in which a recipe is made are collected from various sources and stored in the internet storage. Recipes are also further tagged with information based on categories like Meal—breakfast/lunch/dinner/snack, Taste-spicy/mild/bland, steamed/deep fried/stir fried and so on.

Information from the unstructured data sources which does contain data organized in the standard format (say paragraphs, when data is normally present as tables) like location of restaurant, timing when the meals are served, nutrition information etc need to be processed in a format which can be easily understood. Information like seasonal fruits and vegetables available at location are also stored. The data requires parsing and processing into a more predefined format of information. A pre processor 107 is used to format the data received from the unstructured data and social networking 108 websites. The system is configured to receive updates from structured data cloud 100 and unstructured data cloud 109 on a periodic basis. A local storage 102 area is created to improve performance and accessibility of the personal diet management service. The local storage stores profile information of registered users. The local storage 102 also maintains a small knowledge base of most frequently used recipes 104 and expected body value 105 of nutrients required each day. For each of the frequently used recipes, calorie and nutrient information is also stored. The local storage 102 is created based on food preferences of a population in a city, state or even country. The expected body value 105 of nutrients is stored as recommend by various medical authorities. The expected body value 105 is also stored based on age ranges, nutrients required for overcoming diseases etc. When a user registers for the personal diet management service a lot of personal information is collected by the profile manager 103. The profile information may include data concerning his/her weight of body, height, age, sex and user can make makes a choice for various other factors like level of activity, inclination to obesity, allergies, food preferences, disease and many more. The profile of user is constantly updated based on the food eaten by the user for every meal, user likes and dislikes etc. The local storage 102 can form patterns based on user profiles.

The heart of the system 100 is a data processor 101 which controls the information flow between various blocks Data processor is used primarily for accessing various data available in the internet storage 106 and local storage 102 on real-time basis while application is functioning. Consider an example, if the recipe synthesizer 117 required data related to ingredients used in a recipe, then the data processor will help retrieve appropriate data from Internet storage 106 or local storage 102.

The personal diet management service can be accessed user input device 114. The users may need to pay a fee monthly for subscribing to the personal diet management service. The system 100 allows a user to communicate through both web based interface and mobile based interface. The user communicates with the system through appropriate API's. The user can access the service through a personal computer or laptop or a PDA. A simple cell phone can also be used by the user to access the service. When a mobile based interface is used by the user, location information can easily be obtained. If the user sets an alarm for waking up, the system can generate breakfast recommendations locally and display to the user in the cell phone or pda where this application is installed. The system also alerts user based on the profile information and user settings. This system generates recommendations based on the previous days or past history of vitamins and micro nutrient deficiency. The user can also receive alerts starting a particular time of the day. For example the user may receive alerts with breakfast options from 7 AM to 11 PM, lunch between 12 PM-3 PM and dinner between 7 PM-11 PM. For example, consider a scenario where a user sends information about what he/she had for breakfast, the system calculates calorie and nutrition content of the breakfast consumed and stores it in the body value storage115. The decision engine 111 receives the body value storage 115 along with other parameters from the communication block 112. The recommender 202 then suggests recipes and restaurants serving such recipes to a user. In case the user does not send breakfast information, a single alert is sent to the user before lunch time requesting breakfast information. Overtime the system collects a lot of information on user food patterns, nutritional deficiency and other preferences. Based on the patterns formed, the system also sends across various informative alerts. For example eating breakfast later than 3 hours of waking up may have an impact on the long term health.

Information from the user is received by the communication block 112 through a string generator 113. The string generator 113 generates strings related to relevant keyword from the user received message. The string generator 113 is also responsible for sending information to the user in a simple and compact format. The communication block 112 forms the link between user input devices 114 and the system 100. The communication block has an input and output section. The communication link provides output to the decision engine 111. The strings generated by the string generated 113 are stored as parameters by the communication block 112. Parameters are also received from the body value storage 115 and local storage 102. For example, when a user request for having an American breakfast is received, some of the parameters may be as follows:

Parameter 1: breakfast. In general parameter one is reserved for specifying the meal liked dinner, snack, lunch, breakfast etc.

Parameter 2: American. In general parameter two is reserved for specifying the cuisine like Indian, Chinese, etc. It can also accept cuisines or variations of cuisines found in each state of a country.

Parameter 3: Time. The user can specify a time when wants to have a particular meal.

In case the user does not specify a time, the system considers general time for meals while sending recommendations. The user can also specify at what time he would like to receive recommendations on a daily basis.

Parameter 4: Location. The user can specify a location where he wants to have a meal. The location of the user can also be identified through location of the mobile device.

Parameter 5: Body Value storage. The calculated calorie and nutrient consumption of the user for that day is an important parameter which helps the diet balance identifier 201 of the decision engine 111 in finding the deficiencies in user.

Parameter 6: Allergies. Information on any allergies the user may suffer can be received from the profile manager 103 in the local storage area 102.

Parameter 7:

A domain controller 118 decides where the information is available—local storage area 102 or internet storage area 106, based on the parameters and guides the data processor 102 to request information accordingly. A recipe synthesizer 117 is used where a public search is required for a request received from a user. A search is done in the internet storage 106 area for the recipe. The recipe found is sent to recipe synthesizer 117 via the data processor 101. The Recipe synthesizer 117 breaks down the recipe into ingredients and calculates nutrition value of each ingredient. The calculated calorie and nutrition information is aggregated by an aggregator 104 and sent to the body value storage 115. The body value storage 115 is reset each day at midnight. Before the values are stored inputs are stored about the past history in the form of a deficiency chart which may be used for recommendation of meal in the future. In case the user request is received in the afternoon, the body value storage may already have information about what the user had for morning breakfasts, calorie and nutrition consumption for the day. The body value storage gets updated based on the user request. The body value storage 115 is sent to the decision engine 111 through the communication block 112. The decision engine 111 has a diet balance identifier 201 which identifies any deficiencies the user may have based on the parameters received from the communication block 112 and the expected body value 115 stored in the local storage area102. The diet balance identifier 201 makes use of food pyramid which describes the right quantity of carbohydrate, protein and fats published by government organizations. It identifies deficiencies in diet of a user by comparing the food consumed by the user with recommended daily allowance (RDA) as published by certified organizations. For example consider macronutrient omega 3, the diet balance identifier combines the omega 3 present in food items consumed by the user through the day and compares it with the recommended omega 3 for a day and finally calculates the omega 3 required by the user. The parameters received from the communication block 112 includes the user request, current body value storage, deficiencies user is prone to, allergies the use may have etc. Once the diet balance identifier 201 identifies the deficiency, it sends a report to a recommender with the current body value, the nutrients the user is lacking in ascending order and other information like allergies, diseases etc. The recommender 202 then recommends recipes which can fulfill the deficient nutrient requirements of the user. The recommender 202 also keeps in mind the seasonal availability of food items to fulfill nutritional requirements of a user. The recommender also recommends recipes based on weather conditions. In spring the food recommendations may consist more of refreshing juices like lemonade etc. The recommender 202 also considers user preferences stored in the user profile and location of the user. Based on location of the user, recommender can suggest local favorites. The user preferences like vegetarian, no seafood, chicken but not mutton, vegan, no pork, no beef etc also considered while recommending recipes. The user can store these preferences as compulsory requirements in the system. The user can specify different requirements for each meal as well. The recommender 202 can also suggest restaurants serving such recipes nearby. Users have an option to specify the amount they wish to spend on the meal as well. A deal manager 203 is used to find the location of a restaurant serving the recipe recommended and satisfying user's budget requirements.

Restaurants can also subscribe to the personal diet management service and benefit. When clients are in the restaurants, then question of which recipe will best suit their nutritional needs can be answered by this system based on what they have consumed earlier in the day and any past history data if available like deficiency chart based on past food consumption and profile. Internet Storage 106 will have information of recipe served in the restaurant. The recipe synthesizer 117 can help get ingredients if not published by restaurant in Internet storage area 106 for all standard dishes. Now to identify which recipes are best suitable, relative ranking of recipes are to be performed by 111 Decision Engine.

A method of implementing this ranking can be as below by using quantitative analysis method. For illustration purposes, Data Envelopment Analysis Linear Programming Model is shown below:—

Assume around 500 calories of output is expected by having to get at least 30% of daily recommended Vitamin A, and C in the meal. Also, assume person has had deficient Vitamin D, so he is expected to have 50% of the daily recommended dosage of Vitamin D now. Then the problem statement is as below

Calories->Output expected is 500 Calories

Inputs expected->30% Vitamin A+30% Vitamin B+30% Vitamin C+50% Vitamin D in the meal

Below steps are followed—

Step 1—Consider recipes in the menu and find out calories, vitamins and micronutrient values using recipe synthesizer 117 and Aggregator 116 total vitamin values and calories of each dish. If menu has details, the values can be directly used from Internet storage 106. Decision engine forms and equation as below

Recipe 1 has 400 calories (R1-Cal) and 15% Vitamin A (R1-VitA), 20% Vitamin B (R1-VitB), 25% Vitamin C (R1-VitC) and 60% Vitamin D (R1-VitD)

Recipe 2 has 550 calories (R2-Cal) and 30% Vitamin A (R2-VitA), 25% Vitamin B (R2-VitB), 35% Vitamin C (R2-VitC) and 75% Vitamin D (R2-VitD)

Recipe 3 has 500 calories (R3-Cal) and 25% Vitamin A (R3-VitA), 30% Vitamin B (R3-VitB), 30% Vitamin C (R3-VitC) and 30% Vitamin D (R3-VitD)

Assume following decision variables

wR1—weight applied for Recipe 1

wR2—weight applied for Recipe 2

wR3—weight applied for Recipe 3

Then the relationships between output measures and composite recipe will be as follows

15 wR1+30 wR2+25 wR3

20 wR1+25 wR2+30 wR3

25 wR1+35 wR2+30 wR3

60 wR1+75 wR2+30 wR3

Relationships between input measures and composite recipe will be as follows

400 wR1+550 wR2+500 wR3

Assume E is efficiency index

To rate if recipe B is efficient, the below needs to be solved

Minimize E Such that

wR1+wR2+wR3=1

15 wR1+30 wR2+25 wR3>or=30

20 wR1+25 wR2+30 wR3>or=25

25 wR1+35 wR2+30 wR3>or=35

60 wR1+75 wR2+30 wR3>or=75

−550 E+400 wR1+550 wR2+500 wR3<or=0

E, wR1, wR2, wR3>or=0

Now after solving the above equation if E<1 then recipe B has less Vitamins A, B, C and D with 550 calories compared to the composite recipe. So it is inefficient and hence it can be ranked lower. These equations have to be solved for each of the recipe to look at which recipe is inefficient and can be removed from the recommendation.

The selection of input and output parameters for a recipe can be based on the deficiency chart, if available. Not always all the vitamins and micro nutrients are required to be used in the output. This method helps users to consume optimal calories and still consume all the required vitamins and micro nutrients in their diet. Now the ranking of the recipes can be send to the string generator 113.

In another embodiment, assume around 500 calories of output is expected by having to get at least 30% of daily recommended Vitamin A, and C in the meal. Also, assume person has had deficient Vitamin D, so he is expected to have 50% of the daily recommended dosage of Vitamin D now. Then the problem statement is as below

Calories->Output expected is 500 Calories

Inputs expected->30% Vitamin A+30%Vitamin B+30%Vitamin C+50%Vitamin D in the meal

Also, assume the user has a choice of eating either by cooking at home or in any restaurant he likes, but what to have the best recommendation to eliminate any deficiency in his/her diet.

Some of the steps used are

1. Set objective is to maximize Vitamin D in this meal

2. Constraints are

a. Not to exceed Vitamin A by 30% of recommended daily allowance

b. Not to exceed Vitamin B by 30% of recommended daily allowance

c. Not to exceed Vitamin D by 50% of recommended daily allowance

Now this simple equation using linear programming method can be restated as follows

Maximize VD

Such that
VA<=(30% of RDA values for VA)
VB<=(30% of RDA values for VB)
VD<=(50% of RDA values for VD)
VA,VB,VD>0

In the above equation,

VD—is variable to define vitamin D consumption required for recommendation

VB—is variable to define vitamin B consumption required for recommendation

VA—is variable to define vitamin A consumption required for recommendation

Now the above equation can be converted as below

Maximize Vitamin D, such that

VA+SA=(30% of RDA values for VA)

VB+SB=(30% of RDA values for VB)

VD+SD=(50% of RDA values for VD)

VA,VB,VD>0

In the above equation

SA is the slack variable for vitamin A. This slack variable can be computed by looking for least value of VA in recipes database. The computation in a simple form is difference between the values of right hand side in the above equation (30% of RDA values for VA) minus least value of VA in recipes database. If slack variable is negative set it to zero.

SB is the slack variable for vitamin B. This slack variable can be computed by looking for least value of VB in recipes database. The computation in a simple form is difference between the values of right hand side in the above equation (30% of RDA values for VB) minus least value of VB in recipes database. If slack variable is negative set it to zero.

SD is the slack variable for vitamin D. This slack variable can be computed by looking for least value of VD in recipes database. The computation in a simple form is difference between the values of right hand side in the above equation (30% of RDA values for VD) minus least value of VD in recipes database. If slack variable is negative set it to zero.

By using slack variables as stated above, linear programming equations may be used to solve when the constraints are realistic.

Now solving the above constraint, the ideal values for consuming vitamin A (VA), vitamin B (VB) and vitamin D (VD) required in the recipes can be obtained and these values can be used to locate recipes in recipe databases. These recipes are broadly the ones that are suitable to eliminate deficiencies.

This above method of finding suitable recipes by solving linear programming method can be used for solving multiple deficiencies of vitamins and micronutrients using the below formulae

Assume in the current food consumed so far in the day has the following deficiencies

1. Deficient in VA by 10%

2. Deficient in VC by 20%

3. Deficient in VD by 30%

4. Deficient in Mg (Magnesium) by 10%

5. Deficient in Iron by 15%

Now the equation can be

Maximize->(10)*VA+(20)*VC+(30)*VD+(10)*Mg+(15)*Iron

Such that

VA+SA=(10% of RDA values for VA)

VC+SC=(20% of RDA values for VC)

VD+SD=(30% of RDA values for VD)

Mg+5 mg=(10% of RDA values for Magnesium)

Iron+Siron=(15% of RDA values for Iron)

VA,VC,VD,Mg,Iron<=0

Where VA, VC, VD, Mg, Iron are expected values for consumption to be found out and SA, SC, SD, Smg and Siron are slack variables that can be computed in the same way as shown when solving objective function to maximize VD.

To this linear programming equation more constraints can be added to also ensure certain vitamins and minerals, calories, proteins, fats and carbohydrates are not over consumed. For e.g., say carbohydrates are consumed in excess and want to minimize this. So a constraint can be added to above linear programming equation—

Carbohydrates<=10% and solve the equation.

In another embodiment herein, a scoring mechanism may also be employed.

Assume in the current food consumed so far in the day has the following deficiencies

1. Deficient in VA by 10%

2. Deficient in VC by 20%

3. Deficient in VD by 30%

4. Deficient in Mg (Magnesium) by 10%

5. Deficient in Iron by 15%

In this case, the following scoring model can be used to find which recipe suits best to eliminate or minimize these deficiencies.

Step 1.

Use the equation below for each of the recipes to find the score

10*VA+20*VC+30*VD+10*Mg+15*Iron

Where VA, VC, VD, Mg, Iron are the values of the vitamins in the recipes.

If this equation is solved for many different recipes, the below scores are obtained

Score of recipe 1=5200

Score for recipe 2=6000

Score for recipe 3=3000

Score of recipe 4=4000

Step 2—

If any of the recipes has more vitamins (VA, VC, VD, Mg, and Iron) then RDA values for these vitamins then a negative score is associated to each by computing as below

Neg value for recipe=(Vitamin A value in recipe 1−RDA for vitamin A)+(Vitamin C value in recipe 1−RDA for vitamin C)+(Vitamin D value in recipe 1−RDA for vitamin D)+(Mg value in recipe 1−RDA for Mg)+(Iron value in recipe 1−RDA for Iron)

Assume negative values for the recipes are as below

Neg value for recipe 1=300

Neg value for recipe 2=500

Neg value for recipe 3=700

Neg value for recipe 4=100

Now net value for each recipe is computed by subtracting negative values from the score obtained as below

Recipe 1=5200−300=4900

Recipe 2=6000−500=5500

Recipe 3=3000−700=2300

Recipe 4=4000−100=3900

Thus net score obtained for each recipe can be used to rank the best fit that minimizes most of the deficiencies in an efficient way.

Decision engine can also implement filters based on the below factors to arrive at what best fits user preference and choice. Below are some of the vital filters

1. Allergies and diseases can restrict users to consume some food ingredients can be blocked

2. Geographical food habits means based on the location, users consume certain recipes and having to consider them while blocking other which may not make sense to user is important to make this system usable

3. Cost of food is another criteria to recommend recipe to users

4. Religious sentiments may be considered to recommend as certain type of food are consumed on certain occasions (festivals, celebrations, events etc)

5. Weather of the day is used for recommendation

6. Taste of recipe is another inputs used for decision. At times people want to try something tangy or spicy and these choices need to be considered

7. Local food availability is also important to assess before recommendation

8. Variety of food is important to avoid repeats of same dishes.

9. Seasonal food preference is another consideration that can be used.

10. Locally grown food choices for users to choose. Locally grown definition can be either defined in terms of food that are not travelled (food miles) more than a specific distance before it is made available to users

11. Organically grown food or poultry items where hormones are not used and

certified so can also be another factor to choose.

The restaurants can provide detailed menu information along with calorie and nutrient content, current promotions, timings etc to the system. The deal manager 203 can help user make a web reservation at a restaurant through the system. Restaurants may pay a small fixed transaction fee for a predetermined number of successful web reservations.

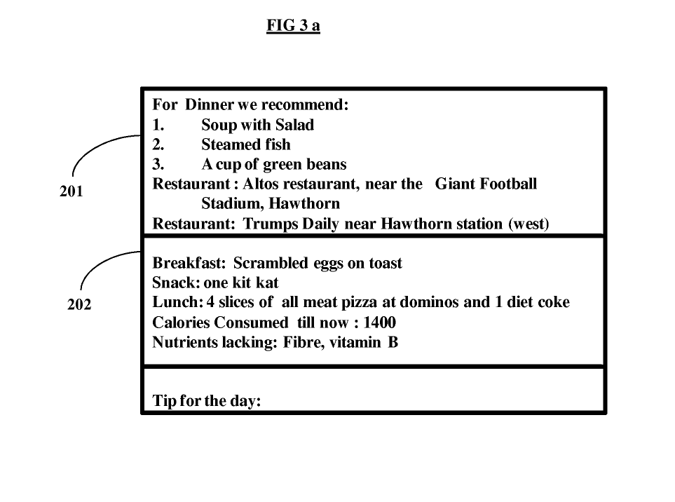

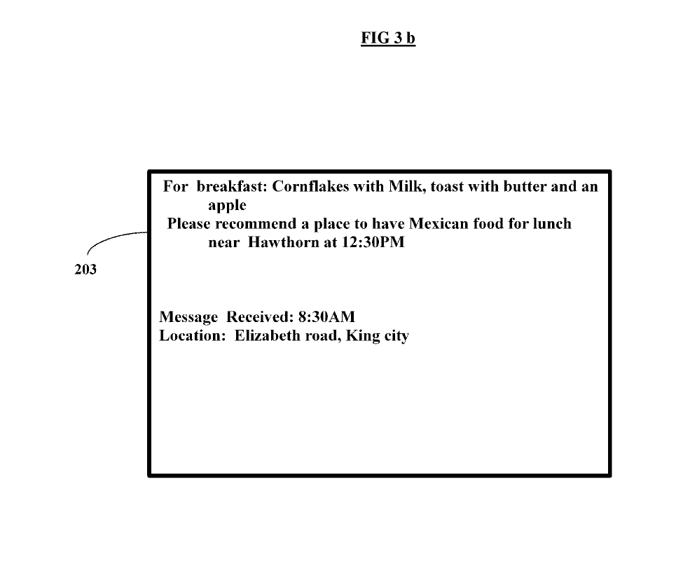

FIG. 3A shows an example of information sent to a user device interface according to an embodiment of the present embodiment. The recommendations 301 provided to user may include names of various recipes and restaurants where such recipes will served. On further request the entire recipe can also be sent. A list 302 of food consumed by the user that day is also shown. The user is also sent the current calories and nutrient information along with deficiencies found in the diet.

FIG. 3B shows an example of information sent by a user from a user device interface. Based on the time information is received the system can start advising the user on food choices/recipes for the next meal. When a user subscriber to the personal diet management service and uses a mobile device interface, details like user location can be easily found. Recommendations can be sent to the user based on user request and current body values.

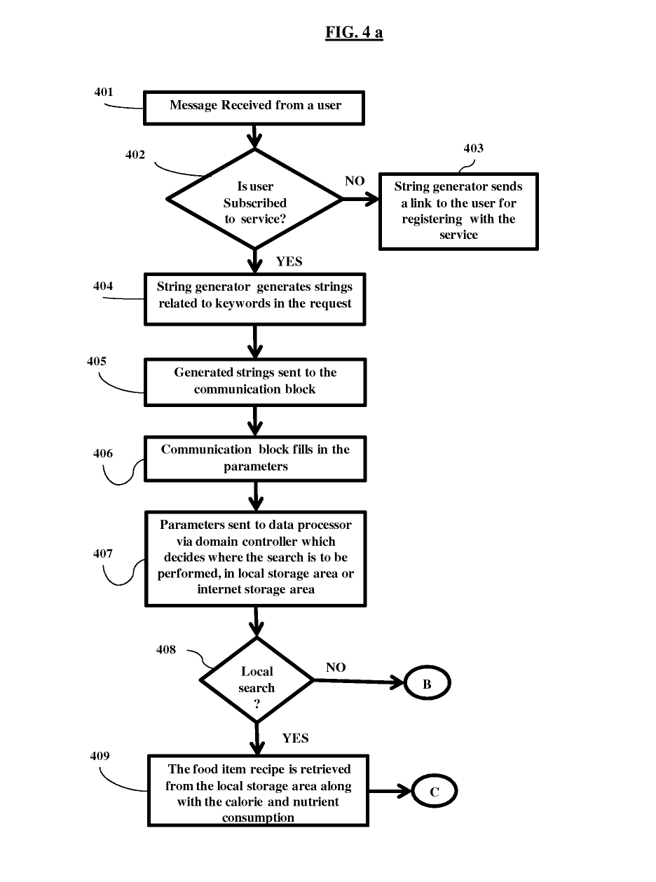

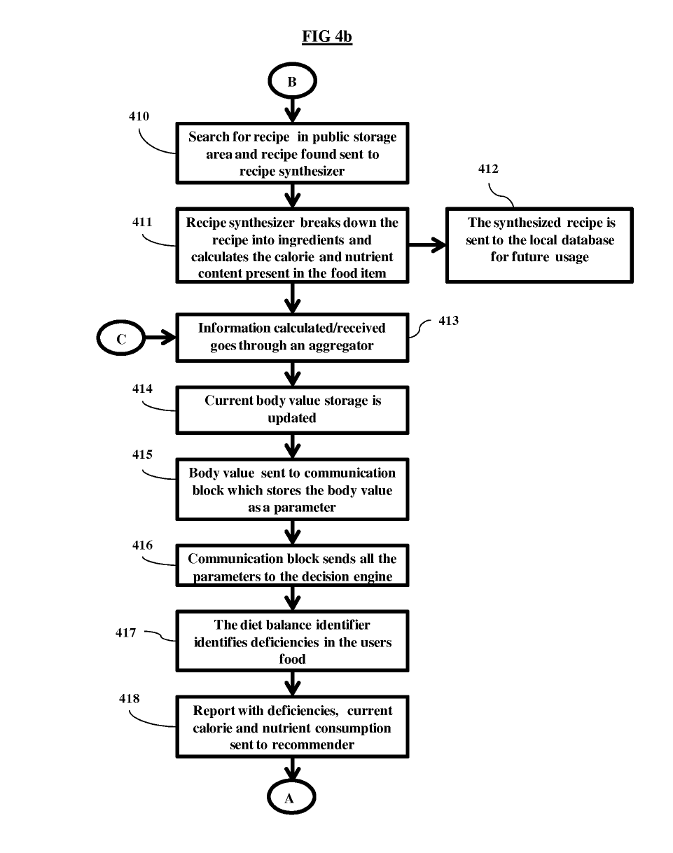

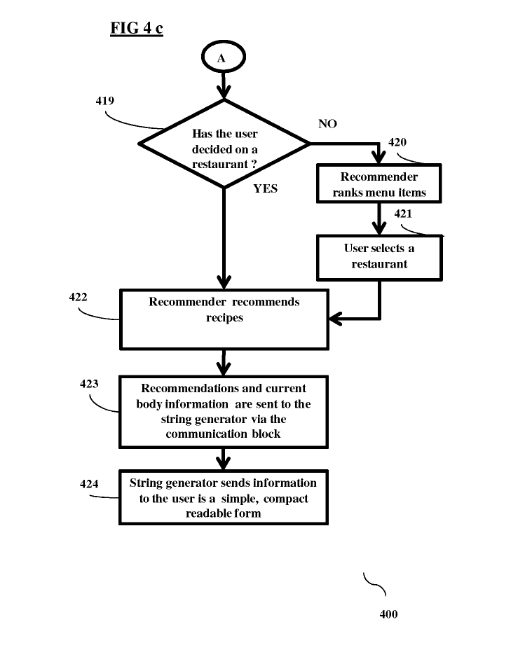

FIGS. 4a, 4b and 4c are flowcharts describing the process flow of the steps used by the system in determining the recommendations and nutritional calculation of current consumption. The process begins with receiving (401) a request from a user. The request may contain what the user had for breakfast/lunch/dinner. The request may also contain what type of cuisine a user may want to have at breakfast/lunch/dinner, the time and location preference as well. The system checks if the user subscribes (402) to the personal diet management service. The user may try to access service through a mobile or web based interface. When a request is received from a mobile interface the user location is can easily be found through a mobile service provider. In case the user is not subscribed to the service, a link for registering to the service is generated (403) by a string generator and sent (403) to the user. If the user subscribes to the service, string generator 113 generates (404) strings related to keywords found in the request. Generates strings are then sent (405) to the communication block 112.

The communication block 112 then fills (406) in the parameters, based on strings generated, previous body value storage for the day and parameter from the local storage area 102. Parameters are sent (407) to the data processor 101 via domain controller 118 which decides (407) whether a search is to be performed (408) in local storage area 102 or internet storage area 106. In case the search is performed in the local storage area 102, the food item recipe is retrieved (409) from the local storage area along with the calorie and nutrient consumption. Information is then sent through an aggregator (413), which updates (414) a body value storage 115. In case the search is performed (410) in the public storage area 101 for a recipe, the recipe found is sent (410) to a recipe synthesizer 117. The recipe synthesizer 117 breaks down (411) the recipe into ingredients and calculates (411) calorie and nutrient content present in the food item. Information calculated is then sent through an aggregator (413), which updates (414) a body value storage 115. The value in the body value storage is then sent (415) communication block 112, which stores (415) the body value as a parameter. The communication block 112 sends (416) all the parameters to the decision engine 111. The diet balance identifier 201 of the decision engines which identifies (417) any deficiencies the user may have based on the parameters received from the communication block 112 and the expected body value 115 stored in the local storage area102. A report with deficiencies, current calorie and nutrient consumption of a user is sent (418) to the recommender 202. The recommender 202 checks (419) if the user has picked a restaurant. If the user has not picked a restaurant, the recommender 202 ranks (420) the menu items in restaurants. The recommender 202 may rank the menu of the restaurants with a specified radius of the current location of the user. The menu items may be ranked based on quantitative analysis—data envelopment analysis using inputs like already consumed food, past history, profile, deficiency chart and so on. This may provide an insight to users about which recipe is most ideal to consume vitamins and micro nutrients and calories are as per daily recommended dosage. The user picks (421) a restaurant based on the ranked menu as presented by the recommender 202. Once the user has picked a restaurant, the recommender 202, then recommends (422) recipes and restaurants based on the deficiency and current calorie and nutrient consumption. Recommendations and current body information are sent (423) to the string generator 113 via the communication block 112. The string generator 113 sends (424) information to the user is a simple and compact format. The information is sent to user mobile device. The profile manager 103 is also updated and users can view the recommendations through a web based interface. The various actions in process flow of FIG. 4 may be performed in the order presented or in a different order. Further, in some embodiments, some actions listed in FIGS. 4a, 4b and 4c may be omitted.

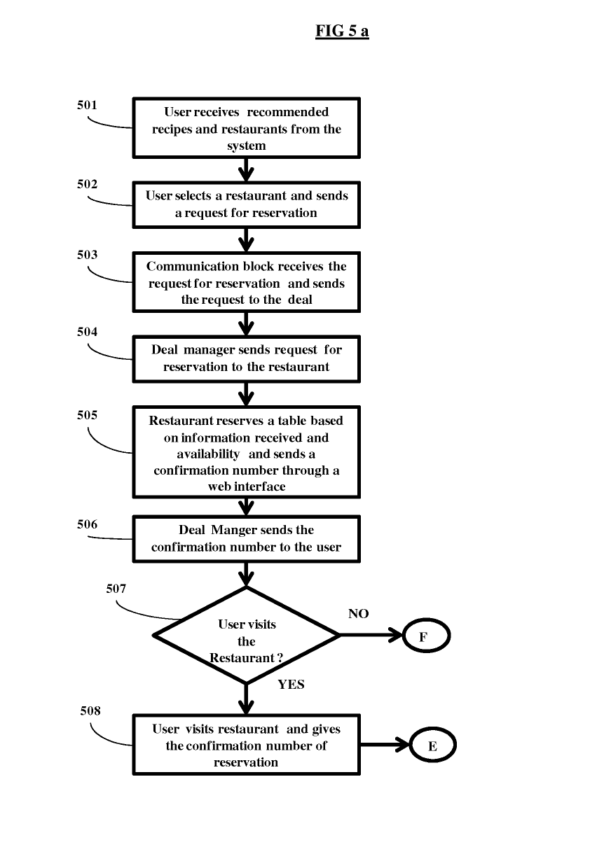

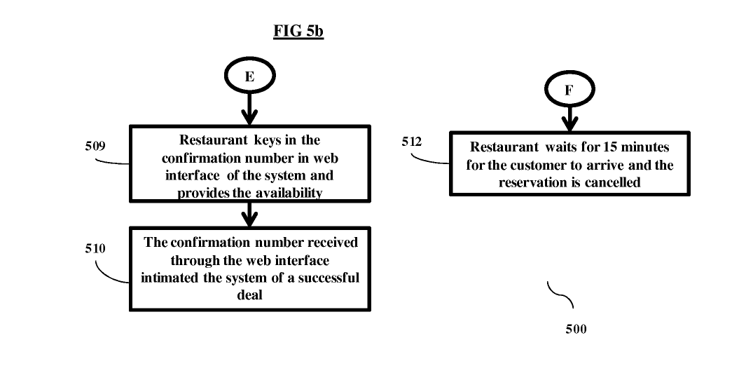

FIGS. 5a and 5b are flowcharts describing how the decision engine 111 of FIG. 1 suggests recommendations and helps user make reservation. The user receives (501) a recommendation with recipes and restaurants. He also receives a small report with current calorie consumption, nutrient deficiency and food which has been consumed on that day. The user selects (502) a restaurant from the recommendations and sends (503) a request back to the application. The request may include details like the no: of people coming for the meal, time when the user would like to come for the meal and any other preferences. The communication block 112 receives the request for reservation and sends the request to the deal manager 203. The deal manager 203 sends (504) request for reservation to the restaurant. The restaurant reserves (505) a table based on information received and availability and sends a confirmation number through a web interface. The deal manager Manger sends (506) the confirmation number to the user. The system checks if the user visits (507) the restaurant. In case the user visits the restaurant, the user provides (508) the confirmation number of the reservation. The restaurant keys (509) in the confirmation number in a web interface and provide the availability to the system. In case the user does not visit the restaurant, the table is kept reserved for the first fifteen minutes of the reservation. If customer does not show up the reservation is cancelled. The various actions in method 500 may be performed in the order presented, in a different order or simultaneously. Further, in some embodiments, some actions listed in FIGS. 5a and 5b may be omitted.

The chef can publish a special recipe in the internet storage area using web interface 106. This is available for purchase in the website 110 and 108 by other restaurants. Once purchased, in the internet storage area, there restaurant menu will be updated with the Chef's recipe with all details of ingredients and nutrition contents for recommendation to users. A transaction fee can be charged by the organization or person for this service. This embodiment can be used only upon establishing a contract with the patent author for creating a market place for Chef's to sell and buy recipe using this innovation which provides service for recommending recipe to users based on nutritional facts.

Further, uses of this application can be extended to create a personalized shopping list. For example consider generation of the grocery shopping list where the user profile is registered in the system. The data can be used to derive how much calories, proteins, fats, micronutrients and vitamins are recommended for consumption by the user on a daily basis. User can customize his/her system to choose as to the number of days he/she would want to consume dishes such as chicken or fish or the number of days he/she would want to consume vegetarian food. This user information can be stored as user shopping preferences.

Using user shopping preferences, various daily menu charts (breakfast, lunch, dinner, snacks, and supper) can be created. For example a user may like the breakfast menu chart and thus decision engine 111 may recommend one or more lunch alternatives. Further, for a given breakfast and lunch combination decision engine 111 may recommend one or more choices for dinner. User can select these choices and add it to the basket. The activity of choosing a daily menu chart is performed for as many numbers of days the user desires. The decision engine 111 provides choices by considering a variety of vegetables, animal protein combinations and so on; hence there is not much of repetition of the previous combinations. The decision engine 111 also considers local and seasonal food availability for recommending recipes/dishes for user to choose. Allergies and user likes/dislikes are also considered while recommending the daily menu chart.

If user wants to create a combined shopping list for meeting needs of his/her family or friends then user profile and his/her family or friends profile is to be considered as a group profile. The decision engine 111 can accept group profile and user preferences for this group and provide recommendations of recipes. Once the choice of recipes is made by the user then the recipes are synthesized into list of ingredients required for these recipes. Further, the recipes are synthesized into list of ingredients required for these recipes. This list of ingredients forms the shopping list for the user to review and make changes. Once the shopping list is finalized and approved by the user, it can be used by the user to shop either in e-groceries or retail shops. The purchase of items can also be based on organically grown sources and coupons/discounts offered by participating retail shops in the network.

Further, when the user visits a doctor, the doctor can examine the patient and his/her medical history and reports such as blood report, electro cardio graph etc. The doctor can use the dashboard to set goals for calories, proteins, fats, micro nutrients, vitamins and so on. This information can be set in the personalized diet management system and henceforth will be consider as the personal profile of the user. Based on the goals, the user will be recommended on a daily basis on the quantity and choice of food consumption. Further, the goals can be used once to set the profile of the user and also can be used by other value added services like creation of shopping lists.

In case the user suffers from diabetes, hyper tension, heart ailments and so on, then this information can be diagnosed by doctors. The dashboard sets the goals for consumption of carbohydrates, proteins, fats, calories, micro nutrients and vitamins. The recommendations provided by the decision engine 111 consider these goals into account and recommends the appropriate food for consumption. If the user is already undergoing a certain therapy and is under supervision of the doctor, then in the personal diet management system certain ingredients that are not be consumed could be set and the recommendation will block such recipes that contain these ingredients.

Consumption of certain foods while using medicines may reduce the effect of medicine taken and such foods will be blocked if patient updates that he/she is consuming the medicine. Further, if the user is to visit a doctor or a diagnostic lab for health check up, then user can update the food consumed in the past few days so that it can help the doctor determine any changes in health conditions. For example excessive consumption of fish on the previous night may show up higher levels of cholesterol in the blood sample. Once the doctor obtains the information regarding excessive consumption of fish, the doctor may decide to give some concession for this higher level of cholesterol and abstain from treating the patient immediately with medication.

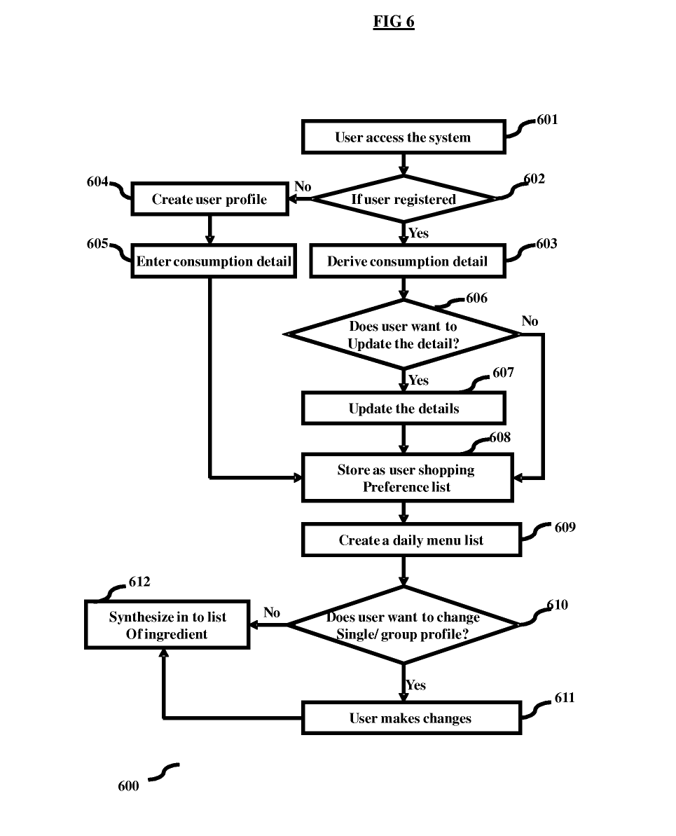

FIG. 6 is an exemplary application depicting creation of a daily menu list, according to embodiments as disclosed herein. Initially, the user accesses (601) the system, the system checks (602) if the user is registered. If the user is registered then the consumption details are derived (603). If the user is not registered then a user profile is created (604) and the consumption details are entered (605). Once the consumption details are derived, the system checks (606) if the user wants to update the details. Once the details are updated (607) then the details are stored (608) as the user's shopping preference list and a daily menu list is created (609). Further, a check is performed to see whether user wants to change (610) his single/group profile. If yes user makes changes (611) and if the user does not want to make changes, then the changes are synthesized (612) into list of ingredient. The various actions in method 600 may be performed in the order presented, in a different order or simultaneously. Further, in some embodiments, some actions listed in FIG. 6 may be omitted.

The examples disclosed above use specific nutrients merely as examples, and should not restrict embodiments disclosed herein.

Embodiments herein also allow chefs to publish new recipe to recipe database and serves as a market place to sell and buy new recipes. It also allows users to create shopping list and buy from the participating network of retail stores. It allows users to upfront know offers from retail stores and make choice to decide from whom to buy. For doctors or nutritionist, embodiments herein helps them to configure user profile while the patient undergoes tests and after this system can use this profile to provide real-time recommendations about diets that users can use.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method for making real time recommendations related to diet of a user by a decision engine, based on a plurality of factors comprising of at least one of
calorie consumption of said user;
nutritional requirements of said user;
preferences of said user; and
consumption pattern of said user.

2. The method, as claimed in claim 1, wherein said decision engine estimates said calorie consumption on a daily basis.

3. The method, as claimed in claim 1, wherein said decision engine estimates said calorie consumption on basis of a plurality of days.

4. The method, as claimed in claim 1, wherein said decision engine estimates said nutritional requirements on a daily basis.

5. The method, as claimed in claim 1, wherein said decision engine estimates said nutritional requirements on basis of a plurality of days.

6. The method, as claimed in claim 1, wherein said decision engine furthers considers factors comprising of type of meal, physiological information of said user, medical history of said user, location of said user, current weather in location of said user, religious preferences of said user, cost of food, purchasing power of said user, taste preferences of said user, food availability at location of said user, seasonal food preferences of said user, a wide variety of food, locally grown food choices, organically or hormone free food sources and current season.

7. The method, as claimed in claim 1, wherein said method further comprises of said user approving said recommendations.

8. The method, as claimed in claim 1, wherein said recommendations may be in the form of at least one of meals; recipes, ingredients for preparing said meals, restaurants for availing said recommended meals.

9. The method, as claimed in claim 8, wherein said method further comprises of offering at least one retail location for obtaining said ingredients based on cost factor to said user.

10. The method, as claimed in claim 9, wherein said method further comprises of offering at least one of coupons; or promotional materials related to said retail location.

11. The method, as claimed in claim 1, wherein said decision engine uses at least one linear programming model for making said recommendations.

12. The method, as claimed in claim 1, wherein said method further comprises of
assigning a score to said recommendations by said decision engine; and
ranking said recommendations by said decision engine on basis of said assigned scores.

13. A system for making real time recommendations related to diet of a user, said system configured for considering a plurality of factors comprising of at least one of
calorie consumption of said user;
nutritional requirements of said user;
preferences of said user; and
consumption pattern of said user.

14. The system, as claimed in claim 13, wherein said system is further configured for estimating said calorie consumption on a daily basis.

15. The system, as claimed in claim 13, wherein said system is further configured for estimating said calorie consumption on basis of a plurality of days.

16. The system, as claimed in claim 13, wherein said system is further configured for estimating said nutritional requirements on a daily basis.

17. The system, as claimed in claim 13, wherein said system is further configured for estimating said nutritional requirements on basis of a plurality of days.

18. The system, as claimed in claim 13, wherein said system is further configured for furthers considering factors comprising of type of meal, physiological information of said user, medical history of said user, location of said user, current weather in location of said user, religious preferences of said user, cost of food, purchasing power of said user, taste preferences of said user, food availability at location of said user, seasonal food preferences of said user, a wide variety of food, locally grown food choices, organically or hormone free food sources and current season.

19. The system, as claimed in claim 13, wherein said system is further configured for taking approval from said user for said recommendations.

20. The system, as claimed in claim 13, wherein said system is further configured for making said recommendations in the form of at least one of meals; recipes, ingredients for preparing said meals, restaurants for availing said recommended meals.

21. The system, as claimed in claim 19, wherein said system is further configured for offering at least one retail location for obtaining said ingredients based on cost factor to said user.

22. The system, as claimed in claim 21, wherein said system is further configured for offering at least one of coupons; or promotional materials related to said retail location.

23. The system, as claimed in claim 13, wherein said system is further configured for using at least one linear programming model for making said recommendations.

24. The system, as claimed in claim 13, wherein said system is further configured for
assigning a score to said recommendations; and
ranking said recommendations on basis of said assigned scores.
